(19) United States
(12) Patent Application Publication
(10) Pub. No.: US 2025/0066164 A1
(43) Pub. Date: Feb. 27, 2025

(54) A Protective Sleeve For A Load Carrying Sling

(71) Applicant: Enduro Softslings B.V., De Goorn (NL)

(72) Inventor: Sytse Van der Molen, De Goorn (NL)

(73) Assignee: Enduro Softslings B.V., De Goorn (NL)

(21) Appl. No.: 18/838,730

(22) PCT Filed: Feb. 22, 2023
(86) PCT No.: PCT/EP2023/054453

§ 371 Date: Aug. 15, 2024

(30) Foreign Application Priority Data
Feb. 24, 2022 (NL) 2031064

(51) Int. Cl. B66C 1/12; D03D 15/283; D03D 15/50

(52) U.S. Cl. CPC B66C 1/122; D03D 15/283; D03D 15/50; D10B 2331/04; D10B 2505/00

(57) ABSTRACT

A protective sleeve is disclosed for covering part of the eye of a load carrying sling. In use, such eyes have a designated inner radius and outer radius. The sleeve comprises an elongate curved tube of flexible material having an opening for receiving the sling, an inner curvature and an outer curvature. The curvatures are configured to form a wrinkle-free surface in contact with the inner radius of the eye when the sleeve is placed over the eye.

### FIELD OF THE INVENTION

The present invention relates protective sleeves and in particular, sleeves used in the field of load carrying slings, particularly for protecting an eye of such a sling. The invention also relates to a method for producing such a sleeve and to a product comprising the sling and the protective sleeve.

### BACKGROUND ART

Load carrying slings are known from the prior art, in particular for use in onshore and offshore projects. Over the years lifting and hauling projects become more complex, requiring resilient slings with large lifting capabilities and high precision. Steel slings have largely been replaced with synthetic slings which are lighter, more flexible, and able to sustain heavy loads. However, as they comprise textile fibres, synthetic slings may be susceptible to failure due to damage of the fibres by sharp edges or rough surfaces of the load. Consequently, it has become necessary to cover portions of the sling with protective sleeves to prevent such failures. The latest sling technology uses high tensile PE fibres that are continuously wound to ensure an exact sling length, measured eye to eye. The fibres are parallel laid, whereby every fibre in the sling is positioned with respect to the designated radius of the eye such that all fibres are subject to the same load. In other words, loops closer to the inner radius of the eye will be shorter than loops closer to an outer radius of the eye.

U.S. Pat. No. 4,350,380A discloses a load carrying sling including a protective sheath over a rope having loops at opposite ends. The sheath is formed of a tough resilient plastics material and has a thick protective layer on the inner surface of the sling with a number of openings in the back of the sheath between the side walls. The openings can be closed by a removable block when the sling is used as a choke hitch.

U.S. Pat. No. 8,123,268B1 discloses a heavy load protective pad for use on industrial slings which includes fasteners on a sleeve forming member which are secured together to encircle and secure the protective pad on an industrial sling at a desired location.

Despite the use of such protective sheaths, industrial soft slings are still susceptible to premature wear and failure. Thus, it would be advantageous to provide an improved protective sleeve.

### SUMMARY OF THE INVENTION

Therefore, according to a first aspect of the invention there is provided a protective sleeve as defined in claim 1. The protective sleeve is adapted for covering part of the eye of a load carrying sling, wherein, in use, the eye has a designated inner radius and outer radius. The sleeve comprises an elongate curved tube of flexible material having an opening for receiving the sling and the sleeve comprises an inner curvature and an outer curvature, which are configured to form a wrinkle-free surface in contact with the inner radius of the eye when the sleeve is placed over the eye.

It has been identified that although protective sleeves may improve protection of a sling, nevertheless, the sleeve itself may be a focus of stress that can even reduce the actual breaking strength. When the sling with its protective sleeve is attached to a lifting point such as a hook or shackle, any imperfections in the sleeve at the point of contact can lead to increased contact pressure and stress concentrations within the sling. This in turn may lead to premature failure of the slings as the areas with increased contact pressure would be overstressed compared to the case of evenly distributed stress. By ensuring that the sleeve has a wrinkle-free surface in contact with the inner radius, such stress concentrations can be avoided. In this context, wrinkle-free may be defined as the surface being devoid of pleats or folds or regions where the flexible webbing material is not flat. The surface may also be devoid of seams, welds, joins or other discontinuities.

The protective sleeve is particularly applicable to slings of the type comprising a sling body having a core and two eyes formed at opposed ends of the body. The body and the eyes may be arranged such that the sling forms a continuous loop. In this context, the invention is intended to be equally applicable to closed eyes, i.e. where each eye forms a closed loop and the body is a single element and to open eyes, where each eye extends around just 180 degrees and the central body comprises two portions joining the respective eyes. The former is sometimes referred to as an eye-and-eye sling, while the latter may be referred to as an endless sling. In all cases, the eyes are curved and comprise a designated inner radius and a designated outer radius. The designated radius is the intended radius of the lifting point to which the eye should be attached. As noted above, the fibres in the sling may be laid to ensure that all fibres are equally loaded when the eye is placed around a lifting point of the designated radius. Deviations from the designated radius, especially smaller radii, would of course lead to unacceptable loading of the sling. Furthermore, variation in the diameter of the lifting point will have an effect on the sling length. This can be highly undesirable if multiple slings are intended to lift a load together, since the loading of each sling which depend on the respective length. When the sling is attached to a lifting point, the portion of the eye that is in contact with the lifting point is referred to as an engaging portion.

The sleeve is particularly applicable to soft slings. In this context, the term soft sling is used to define a sling that is not provided with its own sheath and comprises essentially just a plurality of continuously wound yarns of multiple filaments. The core of the soft sling thus comprises a yarn or bundle of yarns that are wound in multiple loops to form the sling. Continuous winding of the yarns takes place with the requisite radius and spacing to correspond with the designated radius of the respective lifting point. A circumference of each loop is specifically chosen such that the loops close to the inner radius have smaller circumference than the loops close to the outer radius. Due to a difference in the circumference, shorter loops cannot be displaced to the outer radius and vice versa which fixes a position of the loop in the sling ensuring its stability. The yarn may be wound more than 40 times, more than 50 times and even more than 60 times in order to provide sufficient frictional strength to the sling against pull-through. In an embodiment, the sling has less than 100 loops.

The actual lifting strength of the soft sling will be additionally dependent on the number of filaments in each yarn or bundle forming each loop. In an embodiment, the soft sling may be wound with from one to ten multifilament yarns in a bundle. Each yarn may be of from 5000 dtex to 50 000 dtex, preferably between 10 000 dtex and 30 000 dtex, and optionally around 25 000 dtex. The yarns in the bundle may be parallel i.e. untwisted or lightly twisted with a twist of from 1 twist per meter (tpm) to 25 tpm, preferably around 10 tpm. Additionally, each yarn will comprise a plurality of monofilaments. The monofilaments may be of from 1 dpf to 10 dpf (denier per filament) and may also be lightly entangled or twisted together. The filaments are preferably of high tenacity polymer material, including but not limited to UHMWPE and its equivalents, para-aramids and polyester based fibres such as liquid crystal aromatic polyester (LCP). Nevertheless, the sleeve can also be applied to soft slings of other fibres such as polyesters and polyamides.

Furthermore, although for a soft sling, the core is not covered by a sheath, ties, tapes or other provisions to hold the yarns together may be provided, in particular during manufacture and initial handling. These may remain in place within the sheath, to the extent that they do not interfere with operation or otherwise cause pressure points, which the sheath according to the present invention seeks to obviate.

The inner radius and the outer radius are defined for when the sling is under (heavy) load. Due to the finite diameter of the sling core, the inner radius is always smaller than the outer radius.

In an embodiment, a cross-section of the opening is configured to correspond to a cross-section of the sling and a length of the curved tube in a longitudinal direction is sufficient to enclose a major portion of the sling around the eye. It will be understood that the sleeve should cover at least all of the engaging portion of the eye that will make contact with the lifting point and that this should be at least an arc of 180 degrees. Preferably, the sleeve will cover considerably more of the eye, such that the engaging portion is always covered, even if the sleeve should slip in the longitudinal direction. The longitudinal direction is the direction connecting two ends of the sleeve. The sleeve is curved in the longitudinal direction comprising an inner curvature and an outer curvature.

In an embodiment, the sleeve has a radially inner portion and a radially outer portion having the respective inner curvature and outer curvature. Furthermore, the sleeve comprises intermediate side portions between the radially outer portion and the radially inner portion.

In an embodiment, the length of the sleeve varies around a circumference of the opening. The length of the radially inner portion is shorter than the length of the radially outer portion. The length of the intermediate side portions may lie between that of the radially inner portion and the radially outer portion. In an embodiment, the length of the sleeve varies continuously around the circumference. In another embodiment, the length of the sleeve may vary incrementally around the circumference in e.g. from 4 to 20 increments.

In an embodiment, a cross-section of the sleeve may be constant along the whole of its length. In an alternative, the cross-section may change along the length of the sleeve. The cross-section at the ends of the sleeve may be substantially circular while the cross-section of a middle portion of the sleeve may be substantially elliptical. The middle portion may correspond to the engaging portion of the eye of the sling.

In a preferred embodiment, the inner curvature and the outer curvature correspond to the designated inner radius and corresponding outer radius of the eye, respectively. It will be understood that benefits of the invention will already be achieved when these curvatures approximate the respective radii and that the nature of the flexible material of the sleeve will allow it to lie flat and wrinkle-free. In particular, if the curved tube is curved to a greater extent than the eye, the radially inner portion may be wrinkle free even though wrinkles may then form at the radially outer portion. Since this radially outer portion is not under load, there is no or little detrimental consequence for the sling.

The flexible material may comprise any material that can ensure the required protection for the sling and may comprise one or more of the following: textile material, rubber, plastic material, and similar. In particular, the material should be wear and abrasion resistant and can preferably be either produced in a curved form or caused to become curved. In an embodiment the flexible material is not extensible, resilient or stretchable in use, although it may be skewable. Nevertheless, portions of the fabric may be caused to extend or contract during the manufacturing process in order to achieve the desired curved tubular shape.

Most preferably, the material is a textile material. Textile materials that can be manufactured to have a curved tubular shape are most preferred. The textile material may comprise yarn having a weight in range between 700 and 1500 dtex, preferably around 1100 dtex. It is known that knitting processes can produce complex shapes by adding rows and stitches at appropriate positions within the knit. Warp knitted and weft knitted fabrics may be used and knitting can be carried out flat or on a circular knitting machine. Nevertheless, it is noted that knitted fabric has a significant Z-component with yarns extending in a thickness direction of the fabric and encircling yarns in different rows.

Such complex structures may less preferred for use with high load slings although they can be simple to accurately design on a custom basis. Knitted fabrics may also be more prone to abrasion.

In an embodiment, the flexible material comprises a woven fabric. In a woven fabric, such as a plain weave, the yarns lie generally flat in the plane of the fabric and cross each other at a shallow angle. A weave may be smooth and hard wearing and may be less prone to stretching. The woven fabric may be woven in a curved tubular shape or may be caused to assume such shape after weaving.

One way in which the curved tubular shape may be achieved is by forming a straight tubular shape and causing one side thereof to shrink or extend relative to another side thereof. In one embodiment, a woven fabric may comprise warp threads and weft threads and one of the weft threads or the warp threads may comprise high-shrinkage fibres while the other comprises low-shrinkage fibres. The high-shrinkage fibres may be aligned with a length direction of the sleeve and the low-shrinkage fibres may be aligned with a circumferential direction of the sleeve. All of the high-shrinkage fibres may be the same or there may also be a variation in the degree of shrinkage around the circumference.

The fabric may be manufactured using polymer materials, preferably, a polyester. Polyester has shown itself generally suitable as a strong and resilient material for manufacturing sleeves. Additionally, it can be provided with a thermal memory, such that it shrinks when exposed to a given degree of heat. Preferably, at least the high-shrinkage fibres may comprise polyester. The high-shrinkage fibres may shrink from 20% to 60% of its original length upon heating. The high-shrinkage polyester may be a fully drawn polyester yarn.

In an embodiment, a desired shape of the sleeve is formed by combining pieces of fabric comprising selectively thermally treated areas. The sleeve may comprise e.g. three or five such pieces. A position and a size of the thermally treated areas are chosen to create a desired shrinkage pattern. A temperature for the thermal treatment depends on the type of the material and may be in range of 150 to 210° C., preferably around 180° C. After thermal treatment, the pieces of the fabric are connected to form the sleeve with desired shape and properties. The pieces of fabric may be sewed, seamed, stitched, adhered, welded together or similar. Preferably, the sleeve comprises three pieces. Alternatively or additionally, the pieces may be arranged such that a region of the sleeve around the inner curvature belongs to a first piece, while two side pieces are connected along longitudinal edges of the first piece.

In an embodiment, the sleeve comprises regions of relatively higher thread density and lower thread density. The higher thread density may be at the inner curvature and the lower thread density may be at the outer curvature. Alternatively or additionally, different thread density regions belong to different pieces of the sleeve. The higher thread density region is located in the first piece while the lower thread density regions are located in the side pieces. The thread density in each piece may vary throughout the piece. Further, the thread density pattern may be arranged such that the thread density in different pieces is approximately the same around connecting areas of the pieces.

In an alternative embodiment, the thread density may be equal across the whole surface of the sleeve.

As mentioned previously, the sling is preferably of the type that is formed without joint as a continuous loop. In certain embodiments, it may be possible to form the sleeve in situ around the eye. Nevertheless, in general it will be necessary to apply the sleeve to the sling subsequent to manufacture of the sling. This will also apply in cases where the sleeve needs to be removed or replaced. For this reason, in an embodiment, the sleeve comprises a closure allowing the sleeve to be applied around the sling or its eye. The closure may extend along the length of the sleeve, preferably along the complete length of the sleeve. In general, the closure may be provided at the radially outer portion.

The closure may include one or more of the following: a zipper, buttons, hooks and eyes, snaps, ties, hook-and-loop fasteners. Preferably, the closure comprise a zipper.

Additionally, the sleeve may be provided with an anti-twist marking to indicate the respective location of the inner curvature and outer curvature respectively during use. It will be understood that due to the curved nature of the sleeve, it is important for it to be correctly aligned with respect to the orientation of the eye. A marker may visually indicate to a user that this is the case. The marker is preferably of high visibility so that it can be easily seen at a distance, even when the sleeve has been soiled. The marker may be one or more lines extending in a longitudinal direction along the sleeve.

The sleeve may be configured to cover an eye of a sling having a core diameter in a range between 30 mm and 250 mm. The core diameter is understood to be the diameter of the bundle of filaments forming the sling. The core may in general be round in cross-section, although it is not excluded that it be flat, rectangular or oval. Furthermore, the eye of the sling may have a designated inner radius in a range between 22 mm and 1500 mm.

According to a second aspect of the invention, there is provided a load carrying sling having an eye and comprising the sleeve as described above or hereinafter around a part of the eye of the sling.

Preferably, the sling is a parallel laid fibre sling comprising high tensile filaments. The sling may have a minimum breaking limit (MBL) of more than 100 t or more than 1000 t or even more than 3500 t, but less than 20000 t.

According to a third aspect of the invention, there is provided a method for constructing a sleeve for an eye of a load carrying sling, wherein the method comprises steps of:
providing a selectively shrinkable fabric that is subject to shrinking in a first direction but not in a second direction;
forming an elongate tubular sleeve from the fabric with the first direction aligned with a length of the sleeve and the second direction arranged around a circumference of the sleeve; and
selectively shrinking the fabric in the first direction at a first circumferential position in order to form an inner curvature of the sleeve, corresponding to a designated inner radius of the eye.

In an embodiment, the method may further comprise a step of attaching a closure along the length of the sleeve.

In another embodiment, the fabric is a woven fabric comprising high-shrinkage fibres and low-shrinkage fibres woven in different directions. At least one of the low-shrinkage fibres and the high-shrinkage fibres may comprise polyester.

In an embodiment, the selective shrinkage may comprise thermal treatment of at least part of the fabric.

### BRIEF DESCRIPTION OF THE DRAWINGS

The present invention will be discussed in more detail below, with reference to the attached drawings, in which:

FIG. 1 depicts a pair of slings in use, wherein the slings are attached to hooks for lifting a load;

FIG. 2A depicts an enlarged area of a sling of FIG. 1, showing an eye of the sling with a protective sleeve according to the invention;

FIG. 2B depicts an eye of an alternative eye-and-eye sling with a protective sleeve according to the invention;

FIG. 2C depicts a schematic cross-section of a core of a sling with a protective sleeve;

FIG. 3A depicts a protective sleeve according to the invention;

FIG. 3B depicts cross-sections of an opening of the sleeve as marked at CSI, CSII and CSIII in FIG. 3A;

FIG. 4A depicts the sleeve of FIG. 3A in an opened configuration;

FIGS. 4B and 4C depict weaving patterns in enlarged areas IV B and IV C in FIG. 4A;

### DESCRIPTION OF EMBODIMENTS

The invention will be explained in more detail below with reference to drawings in which illustrative embodiments thereof are shown. The drawings are intended exclusively for illustrative purposes and not as a restriction of the inventive concept which is to cover all modifications, equivalents, and alternatives falling within the scope of the present invention. The scope of the invention is only limited by the definitions presented in the appended claims.

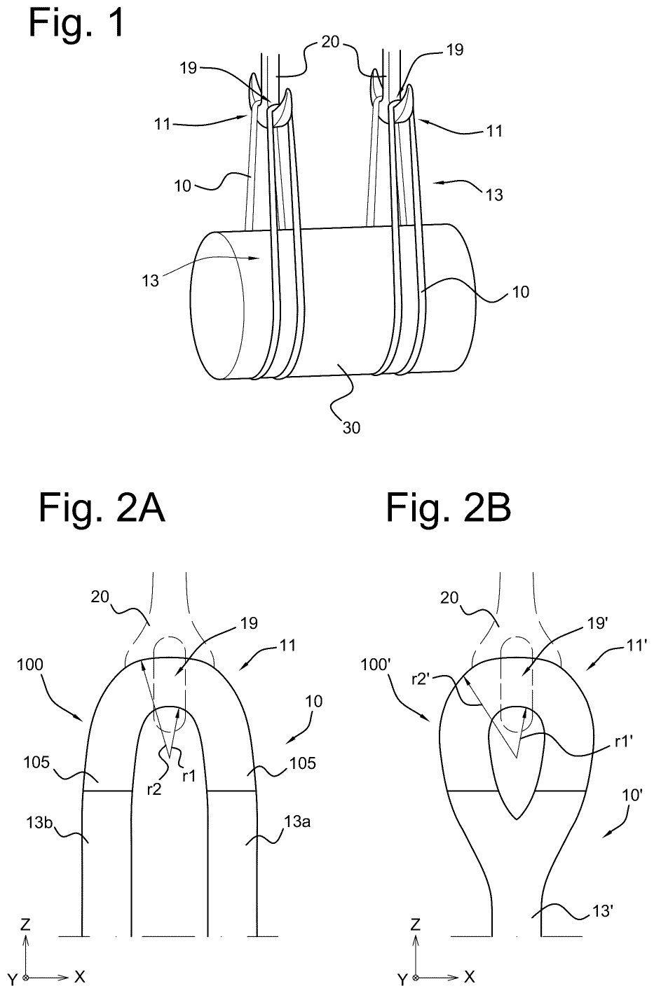

FIG. 1 illustrates two endless slings 10 wrapped around a load 30 and attached to four hooks 20 which are part of a lifting apparatus. A body 13 of the sling 10 forms a continuous loop. Each of the hooks 20 is attached to an eye 11 of the sling 10, wherein a portion of the eye 11 that is in contact with the hook 20 is an engaging portion 19.

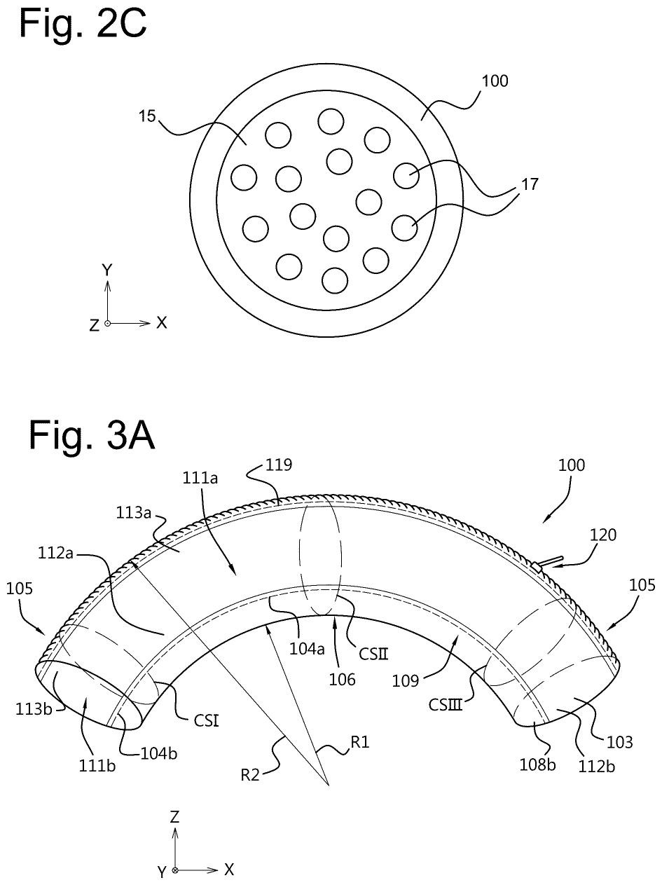

FIG. 2A shows in more detail a portion of the endless sling 10 around the eye 11 when the sling 10 is attached to the hook 20. The eye 11 has an open eye configuration and the endless sling 10 has two body portions 13a, 13b displaced in a longitudinal direction X and connected to the opposite ends of the eye 11. When in use, the body portions 13a, 13b extend in a vertical direction Z. A protective sleeve 100 is placed around the engaging portion 19 such that two sleeve ends 105 are symmetrically positioned around the eye 11. When attached to the hook 20, the eye 11 defines a designated inner radius r1 and a designated outer radius r2.

FIG. 2B illustrates an example where the protective sleeve 100′ is placed around an eye 11′ of an eye-and-eye sling 10′. Similarly as in the case of the endless sling 10, the hook 20 is attached to the engaging portion 19′. The eye 11′ has a closed eye configuration. The body 13 has only one portion extending in the vertical direction Z. In use, the eye 11′ defines the designated inner radius r1′ and the designated outer radius r2′.

FIG. 2C illustrates a cross-section through the sling 10 of FIG. 2A. The sling 10 is a soft sling having a core 15 comprises a plurality of bundles 17 of high tensile filaments which are continuously wound and all aligned along the body of the sling 10. For the sake of clarity, the illustrated embodiment of FIG. 2C shows fifteen bundles 17, which are fifteen loops of the same continuous bundle 17. In the actual embodiment somewhat more than fifteen loops will be required to achieve adequate friction in the sling. Details of the filaments are not shown but it will be understood that each bundle 17 may comprise a number of yarns, with each yarn comprising a number of monofilaments. The protective sleeve 100 is placed directly around the core 15 which is otherwise loose and does not have any other form of sheath.

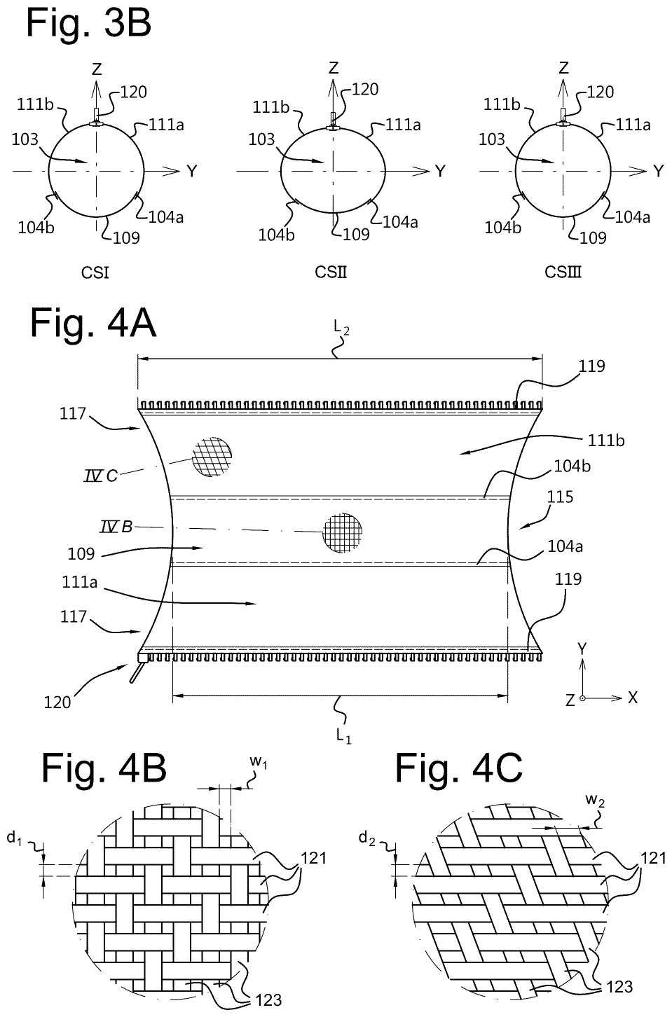

FIG. 3A illustrates the protective sleeve 100. The sleeve 100 has a form of a curved tube 101 with an opening 103 for receiving the sling 10. The sleeve 100 has three pieces: an inner piece 109 having a medial part 106 and two inner piece edges 108a,b extending along the longitudinal direction X, and two outer pieces 111a,b, each having an outer edge 113a,b and an inner edge 112a,b extending in the longitudinal direction X. The inner piece 109 is connected to the outer pieces 111a,b by seams 104a,b such that the inner piece edges 108a,b are sewn to the inner edges 112a,b of the outer pieces 111a,b. The inner piece 109 with its medial part 106 defines an inner curvature R1 along the length of the sleeve 100 in the longitudinal direction X. The outer pieces 111a,b with their outer edges 113a,b define an outer curvature R2 along the length of the sleeve 100. The inner curvature R1 corresponds to the inner radius r1 and the outer curvature R2 corresponds to the outer radius r2. The sleeve 100 has a zipping mechanism 120 connected to the outer edges 113a,b of the outer pieces 11a,b.

FIG. 3B shows cross-sections of the sleeve 100 at three different positions marked in FIG. 3A. The sleeve has substantially circular cross-sections at positions CSI, CSIII close to the sleeve ends 105, shown in FIG. 3A, while the cross-section at position CSII intended for covering the engaging portion 19 of the eye 11 (not shown) has a substantially elliptical shape. However, circumferences of the sleeve at all three positions are approximately the same.

FIG. 4A shows the sleeve 100 in an open configuration. The zipping mechanism 120 is placed along the edges in the longitudinal direction X and attached to the sleeve 100 by sewing means 119. The sleeve 100 is made of a woven material which has a higher thread density region 115 and two lower thread density regions 117 around it. The higher thread density region is located in the inner piece 109, while the lower thread density regions 117 are located in the outer pieces 111a,b. In should be noted that the thread density is not constant in these regions but changes smoothly. The length of the sleeve L1 in the higher thread density region 115 is smaller than the length of the sleeve L2 in the lower thread density region. When placed on the eye of the sling, the higher thread density region 115 covers the inner radius of the eye while the lower thread density regions 117 cover the outer radius of the sling.

FIGS. 4B and 4C show weaving patterns in zoomed areas IVB, IVC marked by black circles in FIG. 4A. The sleeve 100 is made of a high-shrinkage warp threads 121 and low-shrinkage weft threads 123. The zoomed area IVB is located in the higher thread density region 115 of the sleeve 100 wherein the warp threads (or fibres) 121 were thermally shrunk while the zoomed area IVC is located in the lower thread density region wherein the warp threads 121 haven't been thermally treated. Hence the smaller length of the sleeve L1 in the higher thread density region 115 compared to the length of the sleeve L2 in the lower thread density region 117. A distance d1, d2 between consecutive warp fibres in both regions is approximately the same as the thermal shrinkage does not have a significant influence on their separation. However, shrinking results in closely packed weft threads 123 in the higher thread density region 115 as a distance between consecutive weft threads w1 is smaller than a distance between consecutive weft threads w2 in the lower thread density region 117 due to the longer length of the sleeve L2 in this region.

The present invention may be embodied in other specific forms without departing from its essential characteristics. The described embodiments are to be considered in all respects only as illustrative and not restrictive to the inventive concept. The scope of the invention is, therefore, indicated by the appended claims rather than by the foregoing description. It will be apparent to the person skilled in the art that alternative and equivalent embodiments of the invention can be conceived and reduced to practice. In addition, many modifications may be made to adapt a particular configuration or material to the teachings of the invention without departing from the essential scope thereof.

All modifications which come within the meaning and range of equivalency of the claims are to be embraced within their scope.

1. A protective sleeve for covering part of an eye of a load carrying sling, wherein, in use, the eye has a designated inner radius and outer radius, the sleeve comprising an elongate curved tube of flexible material having an opening for receiving the sling and wherein the sleeve comprises an inner curvature and an outer curvature, configured to form a wrinkle-free surface in contact with the inner radius of the eye when the sleeve is placed over the eye.

2. The sleeve of claim 1, wherein a length of the sleeve varies around a circumference of the opening.

3. (canceled)

4. The sleeve according to claim 1, wherein the flexible material comprises a woven fabric.

5. The sleeve of claim 4, wherein the fabric comprises warp threads and weft threads and wherein one of the weft threads or the warp threads comprises high-shrinkage fibres while the other comprises low-shrinkage fibres and the high-shrinkage fibres are aligned with a length direction of the sleeve.

6. (canceled)

7. The sleeve according to claim 5, wherein at least the high-shrinkage fibres comprise polyester.

8. The sleeve according to claim 4, wherein the sleeve comprises first regions and second regions and a thread density is higher in the first regions than in the second regions.

9. The sleeve according to claim 1, wherein the sleeve further comprises a closure extending along a length of the sleeve, allowing the sleeve to be opened for application around the eye.

10. The sleeve of claim 9, wherein the closure include one or more of the following: a zipper, buttons, hooks and eyes, snaps, ties, hook-and-loop fasteners.

11. The sleeve according to claim 1, wherein the sleeve is configured to enclose the eye of an endless sling or an eye-and-eye sling.

12. The sleeve according to claim 1, wherein the sleeve is configured to cover an eye of the sling having a core diameter in a range between 30 mm and 250 mm.

13. The sleeve according to claim 1, wherein the sleeve is configured for a sling having a designated inner radius of between 22 mm and 1500 mm.

14. The sleeve according to claim 1, wherein the sleeve is provided with an anti-twist marking to indicate the respective location of the inner curvature and the outer curvature respectively during use.

15. A load carrying sling having an eye and a protective sleeve provided around a part of the eye, wherein the eye has a designated inner radius and outer radius, the sleeve comprising an elongate curved tube of flexible material having an opening for receiving the sling, with an inner curvature corresponding to the designated inner radius and an outer curvature, corresponding to the outer radius of the eye, such that the sleeve has a wrinkle-free surface in contact with the inner radius of the eye.

16. The sling according to claim 15, wherein the sling is a soft sling, comprising a continuously-wound bundle of high-tensile filaments.

17. The sling according to claim 15, having a minimum breaking limit (MBL) of at least 100 t.

18. A method for constructing a sleeve for an eye of a load carrying sling, wherein the method comprises steps of:
providing a selectively shrinkable fabric that is subject to shrinking in a first direction but not in a second direction;
forming an elongate tubular sleeve from the fabric with the first direction aligned with a length of the sleeve and the second direction arranged around a circumference of the sleeve;
selectively shrinking the fabric in the first direction at a first circumferential position in order to form an inner curvature of the sleeve, corresponding to a designated inner radius of the eye.

19. The method of claim 18, wherein the method further comprises the step of attaching a closure along the length of the sleeve.

20. The method of claim 18, wherein the fabric is a woven fabric comprising high shrinkage fibres and low shrinkage fibres woven in different directions.

21. The method of claim 20, wherein at least one of the low-shrinkage fibres and the high-shrinkage fibres comprises polyester.

22. The method according to claim 18, wherein selective shrinking comprises thermal treatment of at least part of the fabric.
